(19) United States
(12) Patent Application Publication
(10) Pub. No.: US 2023/0344006 A1
(43) Pub. Date: Oct. 26, 2023

(54) LITHIUM-ION BATTERY

(71) Applicant: HONDA MOTOR CO., LTD., Tokyo (JP)

(72) Inventors: Hirotaka Nakagawa, Wako-shi (JP); Ryoma Asano, Wako-shi (JP); Atsushi Tamai, Wako-shi (JP); Sae Shinjo, Wako-shi (JP); Yusuke Kawano, Tokyo (JP)

(21) Appl. No.: 18/131,443

(22) Filed: Apr. 6, 2023

(30) Foreign Application Priority Data
Apr. 20, 2022 (JP) 2022-069764
Apr. 5, 2023 (JP) 2023-061451

(51) Int. Cl. H01M 10/0567; H01M 10/0525; H01M 10/0569

(52) U.S. Cl. CPC H01M 10/0567; H01M 10/0525; H01M 10/0569; H01M 2300/0034; H01M 2300/004

(57) ABSTRACT

What is provided is a lithium-ion battery in which the energy efficiency can be improved by decreasing both the initial resistance value and deterioration resistance value after charge and discharge cycles of the lithium-ion battery and the generation of heat from the positive electrode associated with discharging can be suppressed. A lithium-ion battery having a positive electrode having a positive electrode current collector and a positive electrode active material layer, a negative electrode having a negative electrode current collector and a negative electrode active material layer and facing the positive electrode and an electrolyte layer disposed between the positive electrode and the negative electrode and containing an electrolytic solution, in which, the electrolytic solution contains a solvent containing 1,2-dimethoxyethane and a fluorinated ether and a lithium imide compound that dissolves in the solvent, and at least some of particle surfaces of a positive electrode active material are coated with a membrane containing fluorine.

### BACKGROUND OF THE INVENTION

### Field of the Invention

The present invention relates to a lithium-ion battery.

### Description of Related Art

A capacitor that supplies power to motors and the like is mounted in vehicles such as electric vehicles (EVs) or hybrid electric vehicles (HEVs). It is common to provide a plurality of secondary batteries in a capacitor.

As secondary batteries that are mounted in EVs or HEVs, lithium-ion batteries (LIBs) are in wide use. A lithium-ion battery is lightweight and capable of providing a high energy density and is thus preferably in use as an in-vehicle high-output power supply.

For such in-vehicle lithium-ion batteries, it is desired to decrease both the initial resistance value and the deterioration resistance value in a state where deterioration has progressed due to charge and discharge cycles in order to enhance the output characteristics.

In addition, in-vehicle lithium-ion batteries require high safeness, and thus there is a demand for suppressing the generation of heat from the positive electrodes associated with discharging.

In order to enhance safeness against the generation of heat from lithium-ion batteries, for example, Patent Documents 1 to 4 disclose electrolytic solutions for lithium-ion batteries in which flame retardance is enhanced by selecting a material that is used as a solvent in the electrolytic solutions and mixing the material within a specific range.

### PATENT DOCUMENTS

[Patent Document 1] Japanese Unexamined Patent Application, First Publication No. 2005-340223
[Patent Document 2] Japanese Unexamined Patent Application, First Publication No. 2001-93572
[Patent Document 3] Japanese Unexamined Patent Application, First Publication No. 2021-82516
[Patent Document 4] Japanese Unexamined Patent Application, First Publication No. H10-12272

### SUMMARY OF THE INVENTION

However, in the electrolytic solutions for lithium-ion batteries disclosed in Patent Documents 1 to 4, the flame retardance of lithium-ion batteries was enhanced, but an effect of suppressing the generation of heat from the positive electrode associated with discharging was limited. In addition, there was a problem in that there is no effect of decreasing both the initial resistance value and deterioration resistance value after charge and discharge cycles of the lithium-ion batteries.

This invention has been proposed in consideration of the above-described problems, and an objective of the present invention is to provide a lithium-ion battery in which the energy efficiency can be improved by decreasing both the initial resistance value and deterioration resistance value after charge and discharge cycles of the lithium-ion battery and the generation of heat from the positive electrode associated with discharging can be suppressed.

With such a background as described above, the present inventors newly found that, when a substance with which a specific material has been mixed at a specific proportion is used as a solvent for a lithium-ion battery, at least some of the particle surfaces of a positive electrode active material are coated with a membrane containing fluorine, sulfur and lithium, both the initial resistance value and deterioration resistance value of the lithium-ion battery can be decreased and the generation of heat from the positive electrode can be suppressed. In addition, it was found that at least some of the particle surfaces of a negative electrode active material are also coated with a membrane containing fluorine, sulfur and lithium, coating growth is suppressed and an increase in resistance is suppressed.

(1) A lithium-ion battery of an aspect 1 of the present invention is a lithium-ion battery having a positive electrode having a positive electrode current collector and a positive electrode active material layer, a negative electrode having a negative electrode current collector and a negative electrode active material layer and facing the positive electrode and an electrolyte layer disposed between the positive electrode and the negative electrode and containing an electrolytic solution, in which, the electrolytic solution comprises a solvent containing 1,2-dimethoxyethane and a fluorinated ether and a lithium imide compound that dissolves in the solvent, and at least some of particle surfaces of a positive electrode active material are coated with a membrane containing fluorine.

According to the aspect 1 of the present invention, it is possible to reduce the initial resistance value during discharging and the deterioration resistance value in a state where deterioration has progressed due to charge and discharge cycles, and it is possible to realize a lithium-ion battery having excellent output characteristics. In addition, it is possible to realize a lithium-ion battery in which the generation of heat from the positive electrode associated with discharging is suppressed and the safeness is further enhanced.

(2) An aspect 2 of the present invention is the lithium-ion battery of the aspect 1, in which ethylene carbonate may be further contained in the solvent.

(3) An aspect 3 of the present invention is the lithium-ion battery of the aspect 1 or 2, in which the lithium imide compound may be contained in a concentration range of 1 mol/L or more and 3 mol/L or less relative to the entirety of the electrolytic solution.

(4) An aspect 4 of the present invention is the lithium-ion battery of any one of the aspects 1 to 3, in which the 1,2-dimethoxyethane may be contained in a proportion of mass % or more and 50 mass % or less relative to the entirety of the solvent.

(5) An aspect 5 of the present invention is the lithium-ion battery of any one of the aspects 1 to 4, in which the fluorinated ether may be contained in a proportion of 50 mass % or more and 90 mass % or less relative to the entirety of the solvent.

(6) An aspect 6 of the present invention is the lithium-ion battery of any one of the aspects 1 to 4, in which the fluorinated ether may be contained in a proportion of 75 mass % or more and 90 mass % or less relative to the entirety of the solvent.

(7) An aspect 7 of the present invention is the lithium-ion battery of any one of the aspects 1 to 6, in which the lithium imide compound may be lithium bis fluorosulfonylimide (LiFSI) or lithium bis trifluoromethanesulfonylimide (LiTFSI).

(8) An aspect 8 of the present invention is the lithium-ion battery of any one of the aspects 1 to 7, in which the fluorinated ether may be 1,1,2,2-tetrafluoroethyl 2,2,3,3-tetrafluoropropyl ether (TTE).

(9) An aspect 9 of the present invention is the lithium-ion battery of the aspect 2, in which the ethylene carbonate may be contained in a concentration range of 2 mol/L or less relative to the 1,2-dimethoxyethane.

(10) An aspect 10 of the present invention is the lithium-ion battery of the aspect 2, in which the ethylene carbonate may be contained in a concentration range of less than 8 mass % less relative to the entirety of the solvent.

According to the present invention, it is possible to provide a lithium-ion battery in which the energy efficiency can be improved by decreasing both the initial resistance value and deterioration resistance value after charge and discharge cycles of the lithium-ion battery and the generation of heat from the positive electrode associated with discharging can be suppressed.

### BRIEF DESCRIPTION OF THE DRAWINGS

FIG. 1 is a schematic cross-sectional view showing an example of the layer configuration of a lithium-ion battery of the present embodiment.

FIG. 2 is a graph showing results (temperature characteristics of initial resistance) in Verification Example 1.

FIG. 3 is a graph showing results (and resistance values before and after charge and discharge cycles) in Verification Example 1.

FIG. 4 is a graph showing results in Verification Example 2.

FIG. 5 is a graph showing results in Verification Example 3.

FIG. 6 is observation images showing results in Verification Example 5.

FIG. 7 is observation images showing results in Verification Example 6.

FIG. 8 is a graph showing results in Verification Example 7.

FIG. 9 is a graph showing results in Verification Example 8.

### DETAILED DESCRIPTION OF THE INVENTION

Hereinafter, a lithium-ion battery of one embodiment of the present invention will be described with reference to drawings. The embodiment to be described below is simply a specific description for better understanding of the gist of the invention and does not limit the present invention unless particularly otherwise described. In addition, in some of the drawings to be used in the following description, a portion that becomes a main portion will be shown in an enlarged manner for convenience in order to facilitate the understanding of the characteristics of the present invention, and the dimensional proportion and the like of each configuration element are not always the same as those in actual cases.

A configuration example of a lithium-ion battery including a positive electrode of the lithium-ion battery of one embodiment of the present invention will be described.

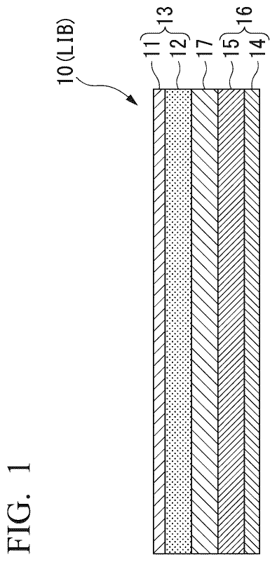

FIG. 1 is a schematic cross-sectional view showing an example of the layer configuration of the lithium-ion battery.

In a lithium-ion battery (LIB) 10, a positive electrode 13 having a positive electrode current collector 11 and a positive electrode active material layer 12 positioned on one surface of this positive electrode current collector 11, a negative electrode 16 having a negative electrode current collector 14 and a negative electrode active material layer 15 positioned on one surface of this negative electrode current collector 14 and facing the positive electrode 13 and an electrolyte layer 17 positioned between the positive electrode 13 and the negative electrode 16 are laminated.

The positive electrode active material layer 12 is a layer containing a positive electrode mixture. The positive electrode mixture has a positive electrode active material, lithium carbonate, a conductive auxiliary agent and a binder.

As the positive electrode active material, an electrode active material enabling the reversible progress of the storage and release of ions, the deintercalation and intercalation of ions or the doping and de-doping of ions and counter anions of the ions (for example, PF₆⁻) can be used.

Specific examples of the positive electrode active material include lithium cobalt oxide (LiCoO₂), lithium nickel oxide (LiNiO₂), lithium manganese dioxide (LiMnO₂), lithium manganese spinel (LiMn₂O₄), a composite metal oxide represented by a general formula: LiNiₓCo_{y}Mn_{z}MₐO₂ (x+y+z+a=1, 0≤x<1, 0≤y<1, 0≤z<1, 0≤a<1 and M is one or more elements selected from Al, Mg, Nb, Ti, Cu, Zn and Cr) (ternary compound), a lithium vanadium compound (LiV₂O₅), olivine-type LiMPO₄ (here, M represents one or more elements selected from Co, Ni, Mn, Fe, Mg, Nb, Ti, Al and Zr or VO), lithium titanate (Li₄Ti₅O₁₂), a composite metal oxide such as LiNiₓCo_{y}Al_{z}O₂ (0.9<x+y+z<1.1), polyacetylene, polyaniline, polypyrrole, polythiophene, polyacene and the like.

In the present embodiment, as the positive electrode active material that is contained in the positive electrode mixture, a ternary compound containing Ni, Co and Mn was used.

As the binder that is contained in the positive electrode mixture of the positive electrode active material layer 12, a well-known binder can be used. Examples thereof include polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), an ethylene-chlorotrifluoroethylene copolymer (ECTFE), and a fluororesin such as polyvinyl fluoride (PVF).

Examples of the conductive auxiliary agent that is contained in the positive electrode mixture of the positive electrode active material layer 12 include a carbon powder such as carbon blacks, a carbon nanotube, a carbon material, a fine metal powder of copper, nickel, stainless steel, iron or the like, a mixture of a carbon material and a fine metal powder and a conductive oxide such as ITO.

In the positive electrode mixture that configures the positive electrode active material layer 12 of the present embodiment, among carbon blacks, ketjenblack that is excellent particularly in terms of a conductive property is used.

Regarding the conductive auxiliary agent, in a case where a sufficient conductive property can be ensured with the positive electrode mixture alone, the positive electrode mixture may not contain the conductive auxiliary agent.

The negative electrode active material layer 15 has a negative electrode active material and a binder as a negative electrode mixture and has a conductive auxiliary agent as necessary. As the negative electrode active material, a well-known negative electrode active material can be used. Examples of the negative electrode active material include metallic lithium, carbon materials such as graphite capable of storing and releasing lithium ions (natural graphite and artificial graphite), a carbon nanotube, non-graphitizable carbon, graphitizable carbon and low-temperature calcined carbon, metals capable of forming a compound with lithium such as aluminum, silicon and tin, amorphous compounds containing, as a main component, an oxide such as SiOₓ (0<x<2) or tin oxide and particles containing lithium titanate (Li₄Ti₅O₁₂) or the like.

As the conductive auxiliary agent and the binder that are contained in the negative electrode mixture, the same conductive auxiliary agent and binder as those contained in the positive electrode active material layer 12 can be used. As the binder that is used in the negative electrode mixture, in addition to those contained in the positive electrode active material layer 12, for example, carboxymethyl cellulose (CMC), styrene-butadiene rubber (SBR), polyimide (PI), polyamide-imide (PAI), polyacrylic acid (PAA) and the like can also be used.

The potential of the negative electrode 16 including such a negative electrode active material layer 15 changes due to lithium ions entering between layers in a carbon material, which is an example of the negative electrode active material, at the time of charging the lithium-ion battery 10.

The electrolyte layer (separator) 17 is present between the positive electrode 13 and the negative electrode 16, transmits lithium ions and isolates the positive electrode 13 and the negative electrode 16. The electrolyte layer (separator) 17 is composed of, for example, a porous film composed of a resin material, a non-woven fabric or the like.

As an electrolytic solution that is used in the lithium-ion battery 10 of the present embodiment, an electrolytic solution containing at least a solvent, in which, 1,2-dimethoxyethane and a fluorinated ether are mixed and a lithium imide compound which is solved in this solvent are used.

Examples of the fluorinated ether that is used in the solvent of the electrolytic solution (fluorine-containing chain-like ether) include compounds having a structure in which some or all of hydrogen atoms of 1,2-ethoxyethane (DEE) or ethoxymethoxyethane (EME) have been substituted with fluorine atoms and the like.

In a case where the number of carbon atoms is small, there is a tendency that the boiling point becomes low and thus there are cases where the fluorinated ether vaporizes when the battery is in operation at high temperatures. On the other hand, when the number of carbon atoms is too large, there are cases where the viscosity of the chain-like ether becomes high and the conductive property of the electrolytic solution deteriorates. Therefore, the number of carbon atoms is preferably four or more and 10 or less.

Specific examples of the fluorine-containing chain-like ether include 2,2,3,3,3-pentafluoropropyl 1,1,2,2-tetrafluoroethyl ether, 1,1,2,2-tetrafluoroethyl 2,2,2-trifluoroethyl ether, 1H,1H,2′H,3H-decafluorodipropyl ether, 1,1,2,3,3,3-hexafluoropropyl-2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H,1H,5H-perfluoropentyl-1,1,2,2-tetrafluoroethyl ether, 1H,1H,2′H-perfluorodipropyl ether, 1H-perfluorobutyl-1H-perfluoroethyl ether, methyl perfluoropentyl ether, methyl perfluorohexyl ether, methyl 1,1,3,3,3-pentafluoro-2-(trifluoromethyl)propyl ether, 1,1,2,3,3,3-hexafluoropropyl 2,2,2-trifluoroethyl ether, ethyl nonafluorobutyl ether, ethyl 1,1,2,3,3,3-hexafluoropropyl ether, 1,1,2,3,3,3-hexafluoropropyl 1H,1H-heptafluorobutyl ether, bis(2,2,3,3-tetrafluoropropyl) ether, bis(2,2,3,3,3-pentafluoropropyl) ether, 1H,1H,5H-octafluoropentyl 1,1,2,2-tetrafluoroethyl ether, 1H,1H,2′H-perfluorodipropyl ether, heptafluoropropyl 1,2,2,2-tetrafluoroethyl ether, 1,1,2,2-tetrafluoroethyl-2,2,3,3-tetrafluoropropyl ether, 2,2,3,3,3-pentafluoropropyl-1,1,2,2-tetrafluoroethyl ether, ethyl nonafluorobutyl ether, methyl nonafluorobutyl ether, 2,2,3,4,4,4-hexafluorobutyl-difluoromethyl ether, 1,1-difluoroethyl-2,2,3,3-tetrafluoropropyl ether, 1,1-difluoroethyl-1H,1H-heptafluorobutyl ether, bis(1H,1H-heptafluorobutyl) ether, nonafluorobutylmethyl ether, 2,2-difluoroethyl-1,1,2,2-tetrafluoroethyl ether, bis(2,2-difluoroethyl) ether, bis(1,1,2-trifluoroethyl) ether, 1,1,2-trifluoroethyl-2,2,2-trifluoroethyl ether, bis(1,1,2,2-tetrafluoroethyl) ether and the like.

Among the above-described fluorinated ethers (fluorine-containing chain-like ethers), in the present embodiment, 1,1,2,2-tetrafluoroethyl 2,2,3,3-tetrafluoropropyl ether (TTE) is used from the viewpoint of voltage resistance, boiling point and the like.

Such a fluorinated ether may be contained in a proportion of 50 mass % or more and 90 mass % or less, more preferably in a proportion of 75 mass % or more and 90 mass % or less, relative to the mass of the entire solvent. When the fluorinated ether is set to a proportion of 75 mass % or more and 90 mass % or less relative to the mass of the entire solvent, at the time of using, for example, aluminum as the positive electrode current collector 11, it is possible to prevent the corrosion of this aluminum due to the electrolytic solution. This makes it possible to further improve the charge and discharge cycles of the lithium-ion battery 10.

In addition, the concentration of the fluorinated ether relative to the electrolytic solution may be in a concentration range of 1 mol/L or more and 5 mol/L or less.

1,2-Dimethoxyethane (DME) that is used in the solvent of the electrolytic solution is a water-soluble liquid having a relatively high boiling point (85° C.) as an organic solvent.

Such 1,2-dimethoxyethane may be contained in a proportion of 10 mass % or more and 50 mass % or less, more preferably in a proportion of 15 mass % or more and 25 mass % or less, relative to the mass of the entire electrolytic solution. The concentration of the 1,2-dimethoxyethane relative to the electrolytic solution may be in a concentration range of 3 mol/L or more and 7 mol/L or less.

In addition, 1,2-dimethoxyethane that is contained in the electrolytic solution can also be substituted with ethylene carbonate.

Ethylene carbonate is a glassy solid (room temperature) having a melting point of 34° C. to 37° C. and is an ester of ethylene glycol with carbon. Ethylene carbonate is a polar solvent, and the addition of ethylene carbonate to the solvent of the electrolytic solution makes it possible to increase the dielectric constant.

Such ethylene carbonate may be contained in a concentration range of 2 mol/L or less relative to 1,2-dimethoxyethane.

Alternatively, the ethylene carbonate may be contained in a concentration range of less than 8 mass % relative to the entire solvent.

When the ethylene carbonate is set to a concentration range of less than 8 mass % relative to the entire solvent, at the time of using, for example, aluminum as the positive electrode current collector 11, it is possible to prevent the corrosion of this aluminum due to the electrolytic solution. This makes it possible to further improve the charge and discharge cycles of the lithium-ion battery 10.

The lithium imide compound is an electrolyte that dissolves in the solvent of the electrolytic solution and is commonly generated by a reaction between lithium amide and lithium hydride. Examples of the lithium imide compound that is used in the present embodiment include lithium bis fluorosulfonylimide (LiFSI) or lithium bis trifluoromethanesulfonylimide (LiTFSI). The addition of such lithium imide to a non-aqueous electrolytic solution as a lithium salt improves low-temperature output characteristics and suppresses the decomposition of the positive electrode surface, which may occur at the time of a high-temperature cycle operation, whereby an oxidation reaction of the electrolytic solution can be prevented.

Such a lithium imide compound may be contained in a concentration range of 1 mol/L or more and 3 mol/L or less relative to the entire electrolytic solution.

When the electrolytic solution of the present embodiment having a configuration as described above is used in the lithium-ion battery 10 of the present embodiment, the particles of the positive electrode active material that configures the positive electrode active material layer 12 are coated with a membrane containing fluorine.

For example, on the surface of a particle of the positive electrode active material, a membrane of a fluorine-containing organic substance is formed by the fluorinated ether in the electrolytic solution. When the particle surfaces of the positive electrode active material are coated with the membrane containing fluorine as described above, it is possible to reduce the reversible capacity loss. Additionally, it is possible to obtain favorable discharge characteristics in charge and discharge cycles. In addition, due to improvement in the stability of the surface of the positive electrode active material, oxygen release at high temperatures is delayed, and the heat generation starting temperature is shifted toward the higher temperature side, whereby high-temperature resistance and safeness can be improved.

According to the lithium-ion battery 10 in which the electrolytic solution of the present embodiment as described above is used, it becomes possible to reduce the initial resistance value during discharging and the deterioration resistance value in a state where deterioration has progressed due to charge and discharge cycles, and it is possible to realize the lithium-ion battery 10 having excellent output characteristics. In addition, it is possible to realize the lithium-ion battery 10 in which the generation of heat from the positive electrode 13 associated with discharging is suppressed and the safeness is further enhanced.

Hitherto, the embodiment of the present invention has been described, but such an embodiment is proposed as an example and does not intend to limit the scope of the invention. Such an embodiment can be carried out in a variety of different forms, and a variety of omissions, substitutions, or modifications can be carried out without departing from the gist of the invention. This embodiment or modification thereof is included in the scope of the invention described in the claims and equivalent thereof in the same manner as being included in the scope or gist of the invention.

### EXAMPLES

The effects of the present invention are verified.

[Electrolyte layers] Electrolytic solutions having the following compositions (samples) were produced. The concentration of each sample indicates a concentration relative to the entire electrolyte.

(Present Invention Example 1) Electrolyte: LiFSI (2.1 mol/L), solvent: EC/DME/TTE (0.9/2.3/3.1 mol/L)

(Present Invention Example 2) Electrolyte: LiFSI (1.4 mol/L), solvent: DME/TTE (3.7/4.4 mol/L)

(Present Invention Example 3) Electrolyte: LiFSI (1.4 mol/L), solvent: EC/DME/TTE (0.2/3.7/4.4 mol/L)

(Present Invention Example 4) Electrolyte: LiFSI (1.4 mol/L), solvent: EC/DME/TTE (1.0/2.9/4.6 mol/L)

(Present Invention Example 5) Electrolyte: LiFSI (1.4 mol/L), solvent: EC/DME/TTE (1.7/2.1/4.7 mol/L)

(Comparative Example 1) Electrolyte: LiPF₆ (1.0 mol/L), solvent: EC/EMC (3.0/7.0 mol/L)

(Comparative Example 2) Electrolyte: LiFSI (1.4 mol/L), solvent: EC/DME/TTE (0.3/3.2/4.7 mol/L)

LiFSI: Lithium bis fluorosulfonylimide

LiPF₆: Lithium hexafluorophosphate

EC: Ethylene carbonate

DME: 1,2-Dimethoxyethane

TTE: 1,1,2,2-Tetrafluoroethyl-2,2,3,3-tetrafluoropropyl ether

EMC: Ethyl methyl carbonate

A sheet-like porous base material was impregnated with each of these electrolytic solutions as the samples to obtain an electrolyte layer.

### [Positive Electrode]

As a positive electrode mixture, a kneaded product of LiCoNiMnO₆ (NMC), lithium carbonate, ketjenblack (KB) and polyvinylidene fluoride (PVdF) was used, and this kneaded product was applied to an aluminum thin film using a coating machine (blade coater) and dried to obtain a positive electrode.

### [Negative Electrode]

As negative electrodes, graphite and silicon oxide were used.

Lithium-ion batteries used for verification were produced by laminating the positive electrode, the negative electrode and the electrolyte layer described above.

### Verification Example 1

The temperature characteristics of initial resistance and the resistance values before and after charge and discharge cycles were verified using the lithium-ion batteries produced with the above-described electrolytic solutions of Present Invention Example 1 and Comparative Examples 1 and 2.

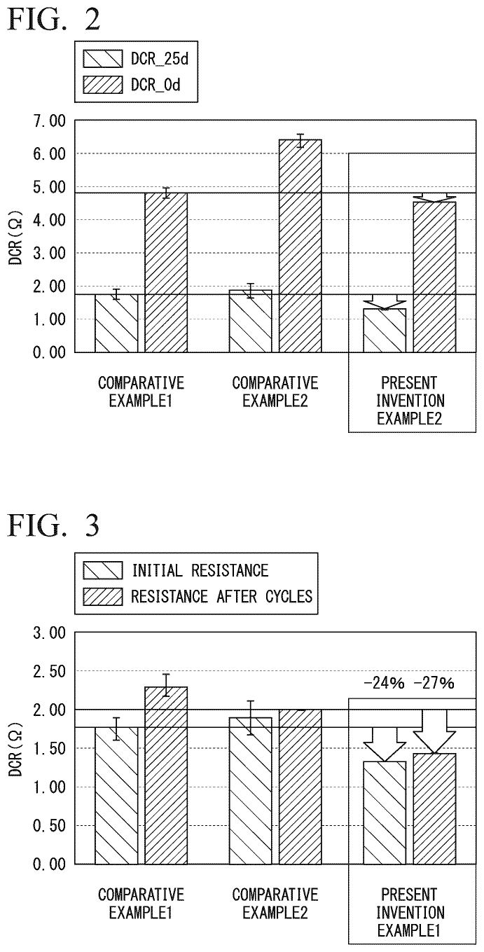

As the temperature characteristics of initial resistance, the direct current resistance value at a measurement temperature of 0° C. (DCR 0d) and the direct current resistance value at a measurement temperature of 25° C. (DCR 25d) were each measured. The set pulse conditions were 10 seconds and 0.2 C to 2.5 C. These verification results are shown in FIG. 2.

In addition, as the resistance values before and after charge and discharge cycles, the direct current resistance values (DCRs) before the cycles and after 50 cycles of charging and discharging were measured at a measurement temperature of 25° C. The set pulse conditions were 10 seconds and 0.2 C to 2.5 C. These verification results are shown in FIG. 3.

According to the results shown in FIG. 2, it was possible to confirm that, in the lithium-ion battery produced with the electrolytic solution of Present Invention Example 1, the initial resistance values were lower from the low-temperature environment where the measurement temperature was 0° C. to the room-temperature environment where the measurement temperature was 25° C. than in the lithium-ion batteries produced with the electrolytic solutions of Comparative Examples 1 and 2.

In addition, according to the results shown in FIG. 3, it was possible to confirm that, in the lithium-ion battery produced with the electrolytic solution of Present Invention Example 1, the direct resistance values became lower by 20% or more than those of Comparative Examples 1 and 2 both before the cycles and after 50 cycles of charging and discharging. Therefore, according to the lithium-ion battery produced with the electrolytic solution of Present Invention Example 1, both the initial resistance value and the deterioration resistance value were low and excellent discharge characteristics were obtained.

### Verification Example 2

The resistance values before and after charge and discharge cycles were verified using the lithium-ion batteries produced with the above-described electrolytic solutions of Present Invention Examples 1 to 5 and Comparative Examples 1 and 2.

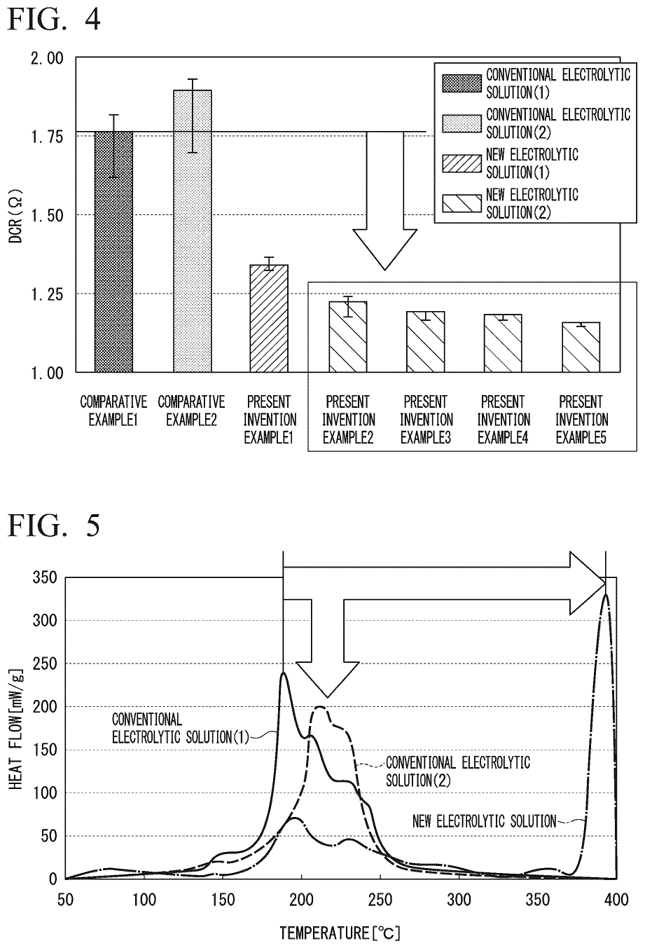

As the resistance values before and after the charge and discharge cycles, the direct current resistance values (DCRs) before the cycles and after 50 cycles of charging and discharging were measured at a measurement temperature of 25° C. The set pulse conditions were 10 seconds and 0.2 C to 2.5 C. These verification results are shown in FIG. 4.

According to the results shown in FIG. 4, in the lithium-ion batteries produced with the electrolytic solutions of Present Invention Examples 1 to 5, the direct resistance values became lower than those of Comparative Examples 1 and 2 both before the cycles and after 50 cycles of charging and discharging. In addition, according to the results of Present Invention Examples 1 to 5, it was possible to confirm that, as the amount of some of DME in the solvent substituted with EC increased, it was possible to further decrease the direct resistance values both before the cycles and after 50 cycles of charging and discharging.

### Verification Example 3

The heat generation stability of the positive electrodes was verified using the lithium-ion batteries produced with the above-described electrolytic solutions of Present Invention Example 1 and Comparative Examples 1 and 2. These verification results are shown in FIG. 5.

According to the results shown in FIG. 5, it was confirmed that, in the lithium-ion battery produced with the electrolytic solution of Present Invention Example 1, it was possible to significantly suppress the generation of heat from the positive electrode at near 200° C. compared with the lithium-ion batteries produced with the electrolytic solutions of Comparative Examples 1 and 2. In addition, it was possible to confirm that it was possible to shift the maximum heat generation peak temperature from near 200° C. to near 400° C. and to realize a lithium-ion battery having enhanced heat generation stability.

### Verification Example 4

The element composition at a depth position less than 10 nm from the surface of a positive electrode active material layer was analyzed using the lithium-ion battery produced with Present Invention Example 1 described above. This analysis result is shown in Table 1. The element composition at a depth position less than 10 nm from the surface of a positive electrode active material layer was analyzed in the same manner as described above. This analysis result is shown in Table 1.

According to the result shown in Table 1, since Ni and the like derived from the positive electrode active material were detected in all of the samples, it is considered that the thicknesses of the membranes were thinner than 10 nm, which is the detection depth of XPS.

In addition, according to the result shown in Table 2, it is considered that the thicknesses of the membranes were thinner than 10 nm, which is the detection depth of XPS, in all of the samples.

### Verification Example 5

Next, in the lithium-ion batteries in which each of the electrolytic solutions of Samples 1 to 5 where LiFSI was used as an electrolyte and TTE, DME and EC were used as solvents was used and an aluminum foil was used as a positive electrode current collector, differences in the degree of corrosion of the aluminum foils due to the compositional ratios of the solvents in the electrolytic solutions were verified. The solvent compositions of the following electrolytic solutions are all compositional ratios when the entire solvent was set to 100 mass %.

(Sample 1) Solvent: TTE/DME/EC (76.2/16.7/7.1 mass %) with a remainder being electrolyte: LiFSI (1.67 mol/L)

(Sample 2) Solvent: TTE/DME/EC (70.0/15/15 mass %), electrolyte: LiFSI (1.67 mol/L)

(Sample 3) Solvent: TTE/DME/EC (55.0/22.5/22.5 mass %), electrolyte: LiFSI (1.67 mol/L)

(Sample 4) Solvent: TTE/DME/EC (40.0/30/30 mass %), electrolyte: LiFSI (1.67 mol/L)

(Sample 5) Solvent: TTE/DME/EC (25.0/37.5/37.5 mass %), electrolyte: LiFSI (1.67 mol/L)

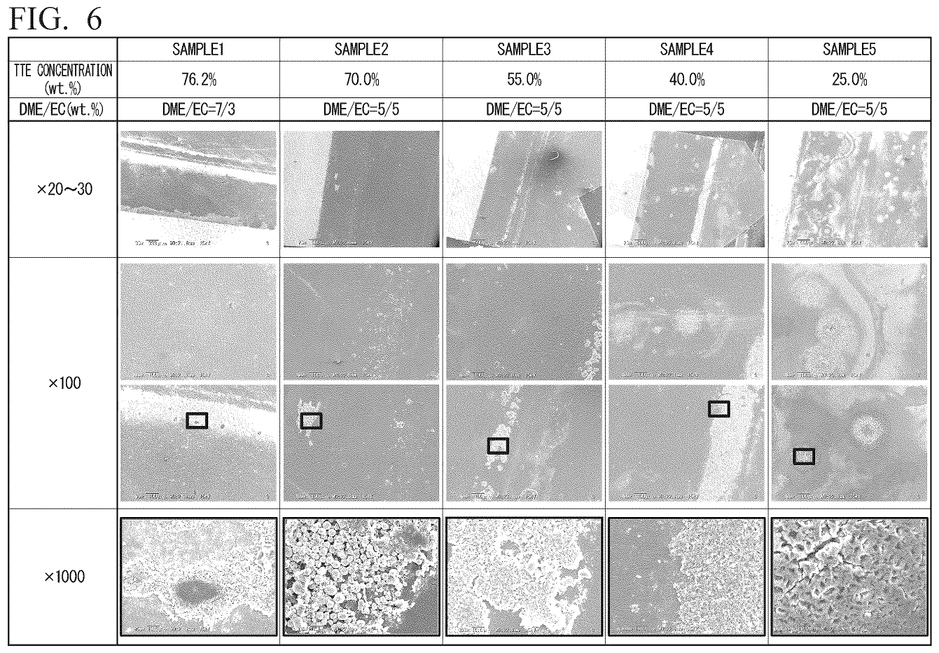

The corrosion statuses of the aluminum foils configuring the positive electrode current collectors at the time of performing 300 cycles of charging and discharging at 60° C. within a range of 3.0 to 4.25 V on the lithium-ion batteries in which each of the electrolytic solutions of Samples 1 to 5 was used were observed with an optical microscope (at magnifications of 20 times, 100 times and 1000 times). These results are collectively shown in FIG. 6 with photographs. Rectangular frame marks at a magnification of 100 times indicate the observation ranges at a magnification of 1000 times.

According to the results shown in FIG. 6, in the electrolytic solutions of Samples 1 to 4, cracks or the like were not found in the aluminum foils configuring the positive electrode current collectors; however, in the electrolytic solution of Sample 5, cracks were generated due to corrosion attributed to the electrolytes. This is considered to be caused that, when a salt (FSI anion) attaches to aluminum, the membrane is broken, and grain dropping is caused, whereby corrosion progresses.

### Verification Example 6

Next, in the lithium-ion batteries in which each of the electrolytic solutions of Samples 6 to 10 where LiFSI was used as an electrolyte and TTE, DME and EC were used as solvents was used and an aluminum foil was used as a positive electrode current collector, differences in the degree of corrosion of the aluminum foils due to the compositional ratios of the solvents in the electrolytic solutions were verified. The solvent compositions of the following electrolytes are all compositional ratios when the entire electrolyte was set to 100 mass %.

(Sample 6) Solvent: TTE/DME/EC (76.2/16.7/7.1 mass %), electrolyte: LiFSI (1.67 mol/L)

(Sample 7) Solvent: TTE/DME/EC (40.0/54/6 mass %), electrolyte: LiFSI (1.67 mol/L)

(Sample 8) Solvent: TTE/DME/EC (40.0/42/18 mass %), electrolyte: LiFSI (1.67 mol/L)

(Sample 9) Solvent: TTE/DME/EC (40.0/30/30 mass %), electrolyte: LiFSI (1.67 mol/L)

(Sample 10) Solvent: TTE/DME/EC (40.0/18/42 mass %), electrolyte: LiFSI (1.67 mol/L)

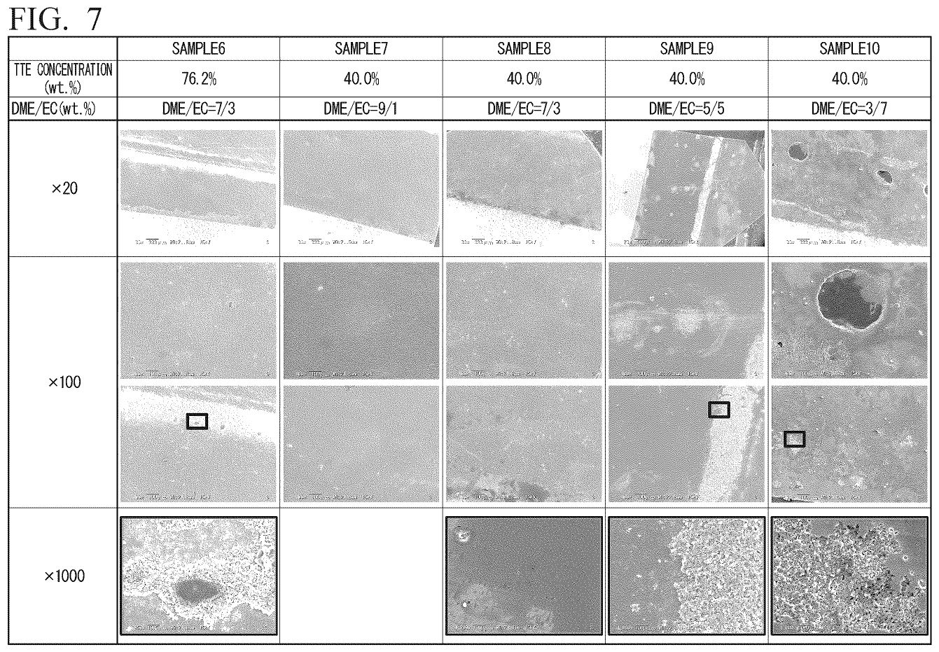

The corrosion statuses of the aluminum foils configuring the positive electrode current collectors at the time of performing 300 cycles of charging and discharging at 60° C. within a range of 3.0 to 4.25 V on the lithium-ion batteries in which each of the electrolytic solutions of Samples 6 to 10 was used were observed with an optical microscope (at magnifications of 20 times, 100 times and 1000 times). These results are collectively shown in FIG. 7 with photographs.

According to the results shown in FIG. 7, in Samples 6 to 8, cracks or the like were not found in the aluminum foils configuring the positive electrode current collectors; however, in Sample 8, cracks were generated due to corrosion attributed to the electrolytes. In addition, in Sample 9, large pores were generated due to corrosion attributed to the electrolytes. This is considered to be caused that, when a salt (FSI anion) attaches to aluminum, the membrane is broken, and grain dropping is caused, whereby corrosion progresses. Therefore, in the case of using an aluminum foil configuring the positive electrode current collector, it is preferable that ethylene carbonate (EC) is contained in a concentration range of less than 8 mass % relative to the entire solvent.

### Verification Example 7

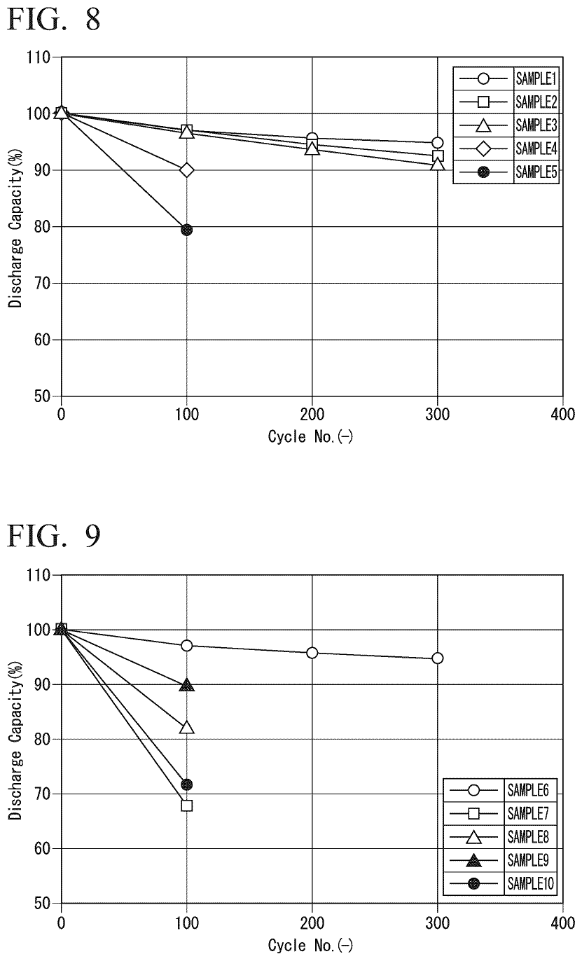

Next, the charge and discharge cycle characteristics (discharge capacities) at the time of performing 300 cycles of charging and discharging at 60° C. within a range of 3.0 to 4.25 V on the lithium-ion batteries of Samples 1-5 for which the electrolytic solutions having different TTE concentrations were used were verified. The results are shown in FIG. 8.

When considering the results shown in FIG. 8 and the results of Verification Example 5, it was possible to confirm that, in the case of using an aluminum foil configuring the positive electrode current collector, it is preferable that TTE is contained in a proportion of 75 mass % or more and 90 mass % or less relative to the entire solvent.

### Verification Example 8

Next, the charge and discharge cycle characteristics (discharge capacities) at the time of performing 300 cycles of charging and discharging at 60° C. within a range of 3.0 to 4.25 V on the lithium-ion batteries of Samples 6-10 in which the proportions of ethylene carbonate (EC) and 1,2-dimethoxymethane (DME) in the electrolytic solution were changed were verified. The results are shown in FIG. 9.

When considering the results shown in FIG. 9 and the results of Verification Example 6, it was possible to confirm that, in the case of using an aluminum foil configuring the positive electrode current collector, it is preferable that ethylene carbonate (EC) in the electrolytic solution is contained in a concentration range of less than 8 mass % relative to the entire solvent.

### INDUSTRIAL APPLICABILITY

The lithium-ion battery of the present invention makes it possible to improve the energy efficiency by decreasing both the initial resistance value and the deterioration resistance value after charge and discharge cycles and makes it possible to suppress the generation of heat from the positive electrode associated with discharging. Lithium-ion batteries for which such a positive electrode for a lithium-ion battery is used make it possible to realize long-distance running only with one round of charging and improve the energy efficiency when used as secondary batteries for vehicles such as EVs or HEVs. Therefore, the present invention is industrially applicable.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10 Lithium-ion battery
11 Positive electrode current collector
12 Positive electrode active material layer
13 Positive electrode
14 Negative electrode current collector
Negative electrode active material layer
16 Negative electrode
17 Electrolyte layer

What is claimed is:

1. A lithium-ion battery comprising:
a positive electrode having a positive electrode current collector and a positive electrode active material layer;
a negative electrode having a negative electrode current collector and a negative electrode active material and facing the positive electrode; and
an electrolyte layer disposed between the positive electrode and the negative electrode and containing an electrolytic solution,
wherein, the electrolytic solution comprises, a solvent containing 1,2-dimethoxyethane and a fluorinated ether and a lithium imide compound that dissolves in the solvent, and
at least some of particle surfaces of a positive electrode active material are coated with a membrane containing fluorine.

2. The lithium-ion battery according to claim 1,
wherein ethylene carbonate is further contained in the solvent.

3. The lithium-ion battery according to claim 1,
wherein the lithium imide compound is contained in a concentration range of 1 mol/L or more and 3 mol/L or less relative to the entirety of the electrolytic solution.

4. The lithium-ion battery according to claim 1,
wherein the 1,2-dimethoxyethane is contained in a proportion of 10 mass % or more and 50 mass % or less relative to the entirety of the solvent.

5. The lithium-ion battery according to claim 1,
wherein the fluorinated ether is contained in a proportion of 50 mass % or more and 90 mass % or less relative to the entirety of the solvent.

6. The lithium-ion battery according to claim 1,
wherein the fluorinated ether is contained in a proportion of 75 mass % or more and 90 mass % or less relative to the entirety of the solvent.

7. The lithium-ion battery according to claim 1,
wherein the lithium imide compound is lithium bis fluorosulfonylimide (LiFSI) or lithium bis trifluoromethanesulfonylimide (LiTFSI).

8. The lithium-ion battery according to claim 1,
wherein the fluorinated ether is 1,1,2,2-tetrafluoroethyl 2,2,3,3-tetrafluoropropyl ether (TTE).

9. The lithium-ion battery according to claim 2,
wherein the ethylene carbonate is contained in a concentration range of 2 mol/L or less relative to the 1,2-dimethoxyethane.

10. The lithium-ion battery according to claim 2,
wherein the ethylene carbonate is contained in a concentration range of less than 8 mass % relative to the entirety of the solvent.
